(19) United States
(12) Patent Application Publication
(10) Pub. No.: US 2019/0027946 A1
(43) Pub. Date: Jan. 24, 2019

(54) ELECTRONIC STYLUS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: TING-JIAN ZOU, Shenzhen (CN)

(21) Appl. No.: 15/822,019

(22) Filed: Nov. 24, 2017

(30) Foreign Application Priority Data
Jul. 20, 2017 (CN) 201710597230.4

(51) Int. Cl. H02J 7/00; G06F 3/0354

(52) U.S. Cl. CPC H02J 7/0042; H02J 7/0052; G06F 3/03545

(57) ABSTRACT

An electronic stylus includes a body, a touching end and a charging end. The touching end and the charging end are arranged at opposite ends of the body. A charging terminal is located in the charging end, the charging terminal being configured for plugging into an external power source. A driving assembly is arranged on the body for driving the charging terminal to extend or retract through the charging end.

### CROSS-REFERENCE TO RELATED APPLICATIONS

This application claims priority to Chinese Patent Application No. 201710597230.4 filed on Jul. 20, 2017, the contents of which are incorporated by reference herein.

### FIELD

The subject matter herein generally relates to an electronic stylus having an improved mechanism for charging.

### BACKGROUND

An electronic stylus is used for operating a touch panel. The electronic stylus may have electronic components therein that need to be charged.

### BRIEF DESCRIPTION OF THE DRAWINGS

Implementations of the present technology will now be described, by way of example only, with reference to the attached figures.

FIG. 1 is a diagrammatic view of an electronic stylus.

FIG. 2 is a cross-sectional view of a charging end of the electronic stylus.

FIG. 3 is similar to FIG. 2, but showing the electronic stylus in another state of use.

FIG. 4 of similar to FIG. 1, but showing the electronic stylus in another state of use.

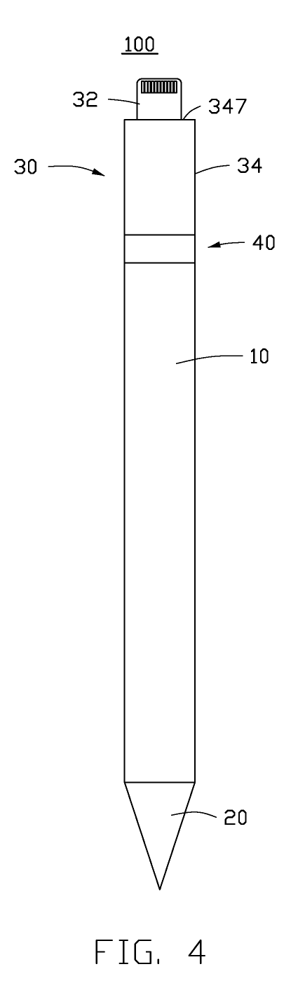

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

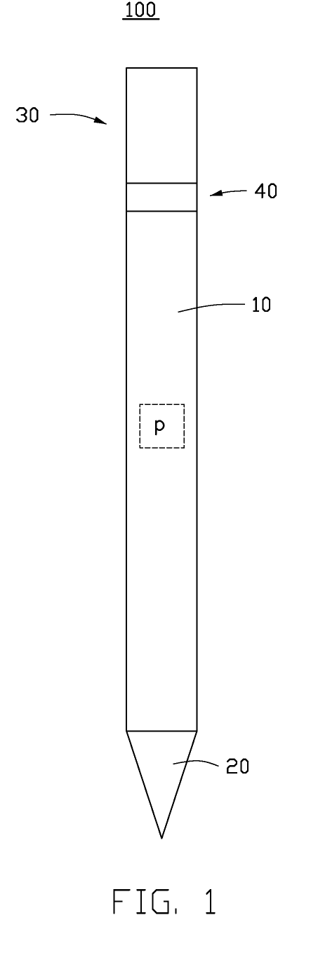

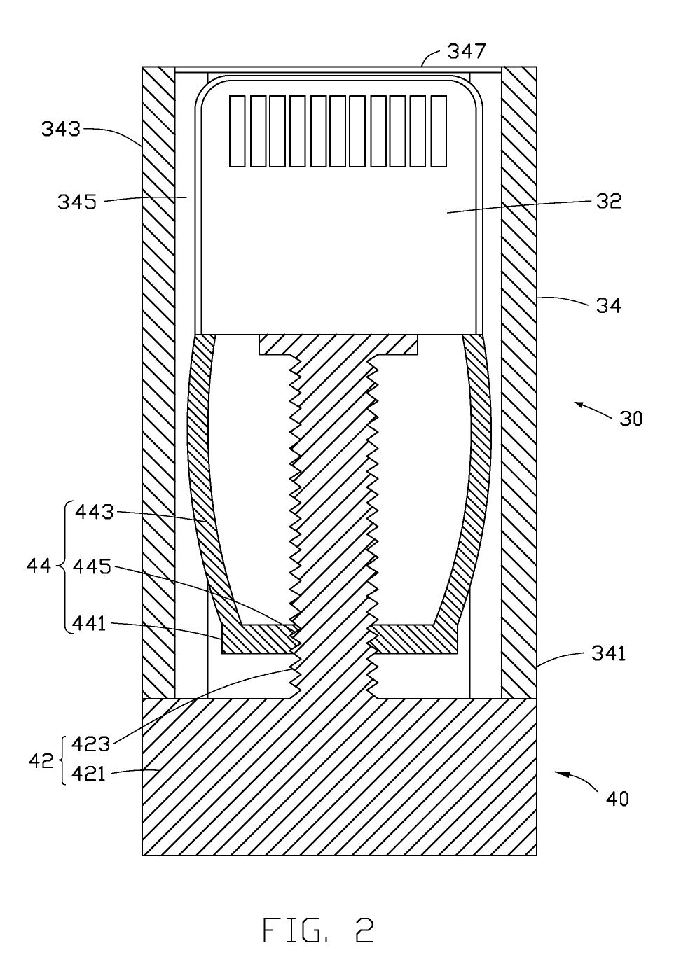

FIG. 1 illustrates an embodiment of an electronic stylus 100. The electronic stylus 100 can include a body 10, a touching end 20, and a charging end 30. The touching end 20 and the charging end 30 are provided at opposite ends of the body 10. The body 10 can have a power supply module p therein. The touching end 20 is adapted to touch a touch panel to generate a corresponding signal. The power supply module p can provide electric power required by the touching end 20. The electronic stylus 100 can further include a charging terminal 32 (shown in FIG. 2) and a driving assembly 40. The charging terminal 32 can be provided on the charging end 30. The driving assembly 40 can drive the charging terminal 32 to extend or retract at the charging end 30.

Referring to FIG. 2, the driving assembly 40 can be inside the charging end 30 and include a rotating assembly 42 and a frame 44. The frame 44 can be threadedly engaged with the rotating assembly 42. The charging terminal 32 can be arranged on the frame 44. The rotating assembly 42 can be rotated to drive the frame 44 to extend or retract the charging terminal 32. The rotating assembly 42 can include a rotating seat 421 and a threaded pole 423. The rotating seat 421 can be provided on the body 10 (as shown in FIG. 1) to allow a user to rotate the rotating assembly 42. The threaded pole 423 is axially coupled to the rotating seat 421 and extends toward the charging end 30. Thus, when the rotating assembly 42 is operated, the rotating seat 421 is rotated synchronously with the threaded pole 423. In another embodiment, a force of the driving assembly 40 for driving the charging terminal 32 can be selected from oil pressure, air pressure, or elastic force.

The frame 44 can include a base 441 and a supporting portion 443 extending from opposite sides of the base 441 so that the frame 44 is U-shaped. A threaded hole 445 can be defined in the base 441, and the threaded pole 423 of the rotating assembly 42 is threadedly engaged in the threaded hole 445. The frame 44 is moved along a length of the threaded pole 423 when the rotating assembly 42 is rotated. The supporting portion 443 is arranged on the base 441, and the charging terminal 32 is arranged on an end of the supporting portion 443 which is away from the rotating assembly 42. The charging terminal 32 is electrically coupled to the power supply module p inside the body 10, and an external power source (not shown) can be coupled to the charging terminal 32 so that the external power source charges the power supply module p. In the present embodiment, the charging terminal 32 is electrically coupled to the power supply module p through the rotating assembly 42 of the driving assembly 40. For example, the threaded pole 423 can define a shaft hole (not shown) through the rotating assembly 42, and electrical connection wires of the charging terminal 32 can pass through the shaft hole to be electrically coupled to the power supply module p.

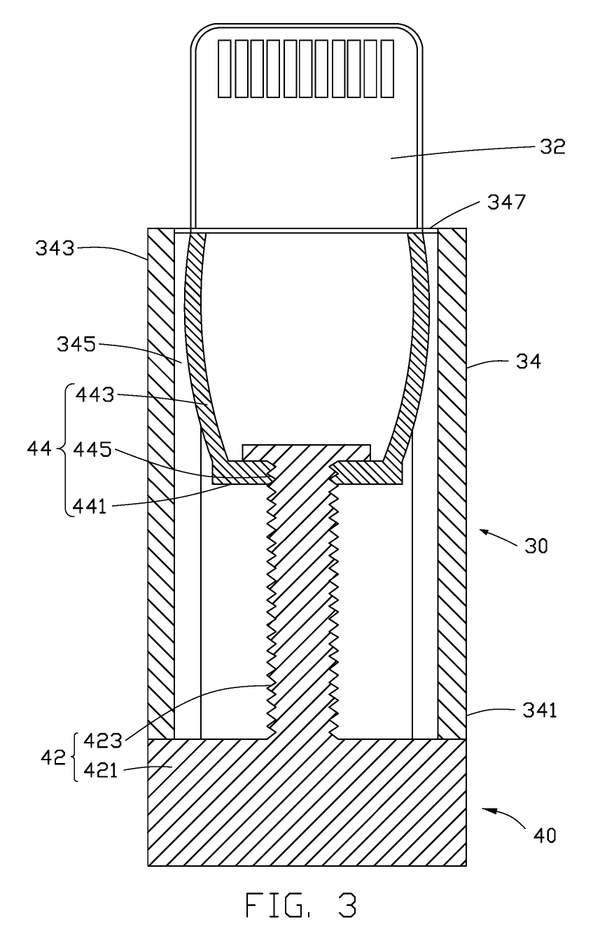

Referring to FIG. 3, the charging end 30 can include a shell 34 having an open end 341 and a closed end 343. The open end 341 is adjacent to the rotating seat 421 of the rotating assembly 42. The charging terminal 32 is received inside the shell 34 and located adjacent to the closed end 343 of the shell 34 (as shown in FIG. 2). An inner side of the shell 34 can define opposite channels 345. The driving assembly 40 can drive the frame 44 and the charging terminal 32 to slide along the channels 345.

In the present embodiment, when the rotating assembly 42 is rotated along a first direction, the threaded engagement between the threaded pole 423 and the threaded hole 445 and a restriction of the channels 345 on the frame 44 cause the frame 44 to slide along the channels 345 toward an exit 347 defined in the closed end 343. The exit 347 has a shape corresponding to a shape of the charging terminal 32 so that the charging terminal 32 can extend through the exit 347. The charging terminal 32 can be received in the charging end 30 adjacent to the closed end 343. The charging terminal 32 protruded out of the exit 347 can couple with an external power source for charging the power supply module p in the body 10. After charging of the power supply module p is completed, the rotating assembly 42 can be rotated along a second direction opposite to the first direction to retract the charging terminal 32 within the shell 34. Thus, it is convenient for the charging terminal 32 to be coupled to an external power source to charge the power supply module p of the body 10. The charging terminal 32 can be protected from being damaged, and a charging function of the charging terminal 32 can be maintained. In addition, the rotating seat 421 of the rotating assembly 42 is provided on the body 10. A diameter of the rotating seat 421 is the same as an outer diameter of the body 10, so that an exterior of the electronic stylus 100 can have a smooth surface and be easy to hold.

In other embodiments, the driving assembly 40 can be a hydraulic assembly, an air pressure assembly, an elastic assembly, or the like.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. An electronic stylus comprising:
a body;
a touching end; and
a charging end;
wherein the touching end and the charging end are arranged at opposite ends of the body;
a charging terminal is located in the charging end, the charging terminal is configured for plugging into an external power source; and
the charging end comprises a driving assembly configured for driving the charging terminal to extend out of the charging end or retract into the charging end;
wherein the charging end comprises a shell comprising a closed end and an open end; the open end is adjacent to the driving assembly, and the closed end is adjacent to the charging end; an exit is defined at an end of the closed end, a shape of the exit being the same as a shape of the charging terminal, the charging terminal extending and retracting through the exit.

2. The electronic stylus of claim 1, wherein the driving assembly comprises a rotating assembly and a frame; the frame is threadedly engaged with the rotating assembly; the charging terminal is arranged on the frame; the rotating assembly is rotated to move the frame with the charging terminal along a length of the rotating assembly.

3. The electronic stylus of claim 2, wherein the rotating assembly comprises a rotating seat and a threaded pole; the rotating seat is arranged on the body; the threaded pole extends through a center of the rotating seat; and the threaded pole extends toward the charging end; the rotating seat and the threaded pole rotate together.

4. The electronic stylus of claim 3, wherein the frame comprises a base and a supporting portion; a threaded hole is defined in the base; the threaded pole is threadedly engaged in the threaded hole; the supporting portion extends from the base; the charging terminal is arranged on an end of the supporting portion away from the base.

5. The electronic stylus of claim 4, wherein a pair of channels is defined in opposite inner sides of the shell; the frame and the charging terminal slide along the channels when the driving assembly drives the charging terminal to extend out or retract.

6-7. (canceled)

8. The electronic stylus of claim 1, wherein a force of the driving assembly for driving the charging terminal is selected from a group of oil pressure, air pressure, or elastic force.
